(19) United States
(12) Patent Application Publication
(10) Pub. No.: US 2025/0298773 A1
(43) Pub. Date: Sep. 25, 2025

(54) 3D DATAFLOW ARCHITECTURE FOR A COMPUTING DEVICE

(71) Applicant: ICAT, LLC d/b/a Turing Micro, Terre Haute, IN (US)

(72) Inventor: George Jeffrey Bennett, Murrieta, CA (US)

(73) Assignee: ICAT, LLC d/b/a Turing Micro, Terre Haute, IN (US)

(21) Appl. No.: 19/085,732

(22) Filed: Mar. 20, 2025

Related U.S. Application Data
(60) Provisional application No. 63/567,808, filed on Mar. 20, 2024.

(51) Int. Cl. G06F 15/80; G06F 15/76

(52) U.S. Cl. CPC G06F 15/803; G06F 2015/768

(57) ABSTRACT

A plurality of simplified CPUs (RAPCs) are provided with data from an input or from memory. The first RAPC completes its simplified task, then turns and hands the data downstream to the next RAPC. Data is routed in a programmable, 3D routing scheme through the array, allowing many simultaneous operations to complete an algorithm as in an assembly line. Completed results go downstream for use as needed.

### BACKGROUND

There is a continuing and growing need for multiprocessor architectures that can achieve very fast computing, are simple to program, yet are flexible enough to execute a large variety of algorithms while minimizing unintended interactions between program elements. There is a tradeoff between speed (execution time and throughput rate) and flexibility.

### SUMMARY

Embodiments of the present invention use an array of simplified CPUs (RAPCs) with a flexible, pipelined pseudo 3D dataflow routing structure to produce superior throughput in a manner analogous to an assembly line. Various embodiments to achieve such goals are provided herein.

Generally, data is passed through a matrix of RAPCs so as many RAPCs as possible can work simultaneously on the data. 3D routing reduces bottlenecks in the data flow and increases algorithm density. Calculations occur in parallel or in series along the whole 3D path, resulting in very high throughput.

The algorithm starts after data is brought to a first RAPC by a Memory Access Unit (MAU) or from an input port. In this example, each RAPC receives data on each Xclk from multiple adjacent locations, synchronizes them, completes one simple operation, then hands the result to the next RAPC downstream. A MAU directs the results to a cache or an output port.

Embodiments of the present invention may have various features and provide various advantages. Any of the features and advantages of the present invention may be desired, but, are not necessarily required to practice the present invention.

### BRIEF DESCRIPTION OF THE DRAWINGS

FIG. 1 illustrates a diagram of data flow using a factory analogy, according to an embodiment.

FIG. 2 illustrates a diagram of an XY communications layout of a RAPC within a RAPC tile, according to an embodiment.

FIG. 3 illustrates a diagram of input routing, according to an embodiment.

FIG. 4 illustrates a diagram of output routing of a RAPC, according to an embodiment.

FIG. 5 illustrates a diagram of a problematic two-dimensional layout, according to an embodiment.

FIG. 6 illustrates a diagram showing data flow and the constructing of the three dimensional architecture in the Z axis in two-dimensions, according to an embodiment.

FIG. 7 illustrates the three-dimensional programming model, according to an embodiment.

FIG. 8 illustrates a diagram via the use of the Z axis to reroute computing and remove adjacent thread blocking of FIG. 5, according to an embodiment.

FIGS. 9A, 9B, 9C, and 9D illustrate the placement of a digital filter algorithm within a RAPC tile, according to an embodiment.

FIGS. 10A and 10B illustrate several different digital filter algorithm layouts and arrangements, according to an embodiment.

FIG. 11 illustrates a conceptual schematic of RAPC fabric layout, according to an embodiment.

FIG. 12 illustrates a schematic of a top level RAPC structure, according to an embodiment.

FIG. 13 illustrates a control bus rerouting structure (the ToCtl block), according to an embodiment.

FIG. 14 illustrates a data qualifier block, according to an embodiment.

FIG. 15 illustrates a four level ReadyCheck structure of channel A of FIG. 13, according to an embodiment.

FIG. 16 illustrates a ReadyCheck logic block (12 identical), according to an embodiment.

FIG. 17 illustrates a priority block, where output encoders use standard 4 to 2 line encoders, according to an embodiment.

FIG. 18 illustrates a Data Multiplexer with 3 identical blocks, according to an embodiment.

FIG. 19 illustrates one data multiplexer, according to an embodiment.

FIG. 20 illustrates a Compute block, according to an embodiment.

FIG. 21 illustrates output and bus control registers according to an embodiment.

FIG. 22 illustrates a local register configuration, according to an embodiment.

FIG. 23 illustrates a single local register of FIG. 22, according to an embodiment

FIG. 24 illustrates the use of indirection in register addressing in FIG. 22, according to an embodiment.

FIG. 25 illustrates control signal generation for FIG. 22, according to an embodiment.

FIG. 26 illustrates a diagram of an I/O driven data input, according to an embodiment.

FIG. 27 illustrates an exemplary diagram of a MAU input structure that brings data to the RAPC fabric, according to an embodiment.

FIG. 28 illustrates an exemplary diagram of a MAU output structure, according to an embodiment.

FIG. 29 illustrates a basic/N up counter with wraparound capability and its representation, according to an embodiment.

### DETAILED DESCRIPTION

### Real Time Computing

A dominant application for this invention is in real time computing. High performance real time computing demands that computations be done within strict time requirements (deadlines), usually externally determined. If deadlines are exceeded, severe impact or failure of a system in which the CPU resides will occur. This conflicts with most CPUs that are designed optimally for internal operations; such designs are said to be ‘CPU-centric. More complex CPUs are usually more CPU-centric. Low latency (here defined as throughput delay) and low overall execution times from faster computation directly result in improved real time system performance.

Any time a CPU is shared between multiple or unrelated tasks (multi-tasking) as in real time computing, many conflicting requirements are created. Several programs (herein referred to as “threads”) must run in an orderly fashion without interfering with each other. Common resources must be shared in an orderly manner. The danger of conflicting variables, common memory and CPU resources, and constraints on memory size create major debug nightmares if not carefully organized. Program threads are usually short due to system and time constraints.

### Multiprocessing Architectures

Multiple CPUs can raise real time computing performance. The tradeoff is a more sophisticated communications mechanism between CPUs. As the CPU count rises, communication rapidly becomes unwieldy and restricts performance. Also, software tasks must be carefully partitioned between CPUs, since inter-CPU communication is hazardous from a debug standpoint. Large CPU counts necessarily demand more rigid data structures, which restrict the applications of these arrays.

There is a continuing need in all types of multi-CPU computing for better flexibility in functional partitioning, handling the computing context, decreasing latency and reducing timing overhead.

### Processor Arrays

Graphic Processing Units (GPUs) are used when a lot of parallel, regular computations are needed. Thousands of computational units with similar programs modify regularly arranged, largely parallel data computations. With these architectures there arises a synchronization problem requiring periodically halting some CPUs while others catch up. Throughput improvement sees diminishing returns as the number of computing elements goes up, especially with ill-defined problems or indeterminate program loops. Memory architectures must be carefully organized for maximum throughput because the memory-CPU data path is a major bottleneck.

Systolic arrays also have very regular structures, which require the data, algorithm and I/O structure to be structured in a regular manner.

### Dataflow and Hardwired Architectures

Reduction of main memory accesses has been addressed using dataflow architectures. Data is fed serially and typically continuously through several computational devices, each performing a separate operation on the data, which is then returned to main memory after several operations. This approach is used by hardwired specialty computational engines (such as gate arrays, including field programmable gate arrays or FPGAs). In this regard, an FGPA that is specifically programmed to perform and implement the invention herein. Dataflow architectures in general are fast but also inflexible.

### The Mapping Problem

Whatever the architecture used, coordinated Multi-CPU processing arrays require extensive mapping of the route the data takes as it is passed through the architecture. Computational algorithms must conform to the physical layout of the computing devices. This mapping requirement forces the programmer to figure out how the data needs to flow through the computing engines.

Multi-CPU architectures working on common tasks make it difficult to plan real time operation due to this mapping problem. Typically, the entire computing sequence of each device must be carefully orchestrated. In hardwired logic chains, a major portion of the design is called place and route; logic elements’ relative positions affect the design's performance strongly. There is a continuing need for simpler ways to map algorithms into multiple CPU architectures.

There is a need to minimize the routing and timing problems within a computing array to achieve high speed, make the computing array flexible and maintain separate variable spaces for multiple computing threads (data encapsulation). There is always a need to minimize computational hardware for cost and complexity reasons, especially with processor arrays where the CPU design is used repeatedly.

Disclosed herein is a very flexible multiple CPU architecture that allows easy routing to optimize dataflow through the architecture, yet is flexible enough to allow rapid reorganization to handle entirely new program threads in an agile manner.

### The 3D Dataflow Architecture

We describe in this section a new data movement architecture, independent of the particular computation performed. The present application refers to the computation CPU used in the architecture as a Reconfigurable Algorithmic Pipeline Core (“RAPC”) to distinguish it from a standard CPU. The data movement architecture is independent of the data path width and the type of computation done (for example, fixed or floating point computations). All data paths within the architecture are clocked synchronously by the transfer clock, Xclk. This application deals exclusively with Xclk and does not address the use of clocks internal to the RAPC.

This architecture concentrates on making the RAPC as small and simple as absolutely possible. The computing algorithm is executed by the routing of data between a large number of tiny, minimized RAPCs.

### The Factory Floor Model—an Analogy

There are requirements that multi-core architectures put on the design's hardware. An analogy is provided throughout this document to help explain this but is only used as an exemplary analogy:

When cars first were built, master mechanics were hired to build each car from the ground up. Surrounded by parts and tools, each mechanic would hand craft the automobile. The mechanics had to be superbly trained assembly experts.

Henry Ford changed this by introducing the assembly line, made up of a large number of much simpler, streamlined assembly stations. Raw parts are loaded at one end of the assembly line by runners who manage the logistics. The work is passed by conveyor belt (‘flows’) between workstations, each of which accomplishes a simple task. Each worker no longer worries about where the car came from; it is delivered to him from the ‘upstream’ workstation by conveyor belt with a work tag to tell him what is needed. If, for instance, he is tasked with installing radios, he might have 4 different types of radios stacked on 4 shelves in his workstation, with the tools for each type of radio organized in the same manner. He reads the work tag, installs the corresponding radio (or ignores the car if none was called for), and he is done. He doesn't worry about where the car goes next (the ‘downstream workstation’); the conveyor belt routes the car as it is built.

Using this approach, assembly line work becomes optimally simple, needing only unskilled labor. The car's complexity results from the layout of the assembly line and the combined efforts of many simple work stations.

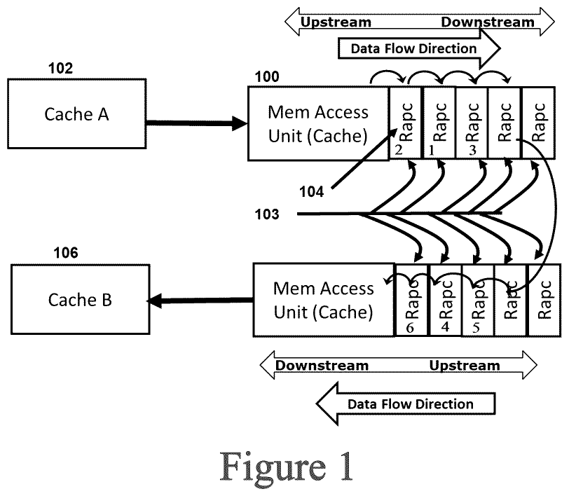

This application discloses a RAPC and physical architecture programmable to fit this factory analogy—the equivalent of unskilled labor in a factory (FIG. 1). The data path (‘conveyor belt’) for this simplified example algorithm is bent in the middle to return finished data to the same side of the computing device (the “chip”) that the raw data came from. In this example, each RAPC receives data on each Xclk from only one adjacent location, then hands it only to the next location after one simple operation has been completed.

As shown in FIG. 1, runners (called memory access units or “MAUs” 100) bring in the necessary parts (the data) from Cache A 102, and give them to the location of the first RAPC worker 104. Each successive RAPC worker 103 completes his greatly simplified task, then hands the data to the next RAPC station 103.

### Upstream and Downstream

Data is handed from one end of the factory floor down the line (downstream), crosses over to the adjacent line, then comes back (again called downstream, though the opposite direction) to the second local cache B 106 where the completed data are stored as directed by the lower portion of the MAU.

We introduce useful nomenclature here. Consider specifically RAPC 1 in FIG. 1. In each data transfer on the data path, the upstream RAPC 2 (or MAU) provides the data, while the downstream RAPC 3 receives it. However, when the data flow direction is reversed, as in the bottom row, RAPC 4 sees RAPC 5 as upstream and RAPC 6 as downstream.

### Simplified Hardware

When we build a hardwired version of this data path, we find no need for the ‘data memory fetch and data write’ sequence of a standard CPU. Our assembly line only needs to include a synchronizing mechanism in each RAPC, so the RAPC will begin processing only when an input is present. Also, each RAPC would perform only one operation. No program counter, program memory or fetch and decode is needed. More than half of the parts of a typical CPU are eliminated.

Also, each data doesn't have to wait until the preceding data finishes the path. Data can fill the path (known in a factory as ‘work in process’ or WIP). The maximum steady state throughput of the pipeline is determined by its slowest RAPC operation, regardless of the length of the computation path. Only total delay time (latency) is affected by a longer algorithm.

A third advantage also is compelling; speed. Simple addressing and the lack of instruction fetches substantially reduce RAPC size which increases speed. The much smaller RAPCs are closer together, reducing data path delays.

Fourth, most CPUs execute more than one operation at a time; internally, they overlap instruction fetches and decoding, data fetches and writes. This overlap is called a pipeline structure, which contributes strongly to rigidity because any branch or out of order calculation requires dumping the pipeline. In FIG. 1 it is clear that the RAPC needs no program fetch; the instruction can even be statically decoded because it's the only instruction in the program. Data reads come only from adjacent RAPCs or the RAPC's internal resources, while data writes also go only to the RAPC's internal resources or adjacent RAPCs. The entire data processing flow is pipelined externally through the RAPCs from one end of the datapath to the other since the operations of multiple RAPCs overlap. We refer from now on to the architecture as an externally pipelined dataflow architecture; the data path will be referred to interchangeably as the pipeline, equivalent to a factory conveyor belt for data.

In this pipeline, the second MAU (bottom) puts the results into Cache B 106. This routing is prearranged by the compiler and the data route configuration is installed in each RAPC. Data is returned to main memory only after the whole block of calculations is done and written to cache B. Main memory is then accessed by block transfer, which greatly speeds up access. The data thus ‘flows’ down the pipeline from the upstream Cache A through the RAPCs to the downstream Cache B, then back to main memory.

### Branches and Conditional Statements

In a real dataflow situation our ‘conveyor belt’ must flow in 2D (X and Y direction) to allow more complex algorithms to be executed. This results in many inefficiencies and bottlenecks. Here is an example of an XY mapping problem using simple pseudocode that would implement a conditional branch.

IF( A<B, GOTO L1)
ELSEIF( A>B, GOTO L3)
ELSE
(calculation 2 takes 8 steps)
GOTO L4
L3: (calculation 3, takes 6 steps)
GOTO L4
L1: (calculation 1, takes 4 steps)
L4: continue

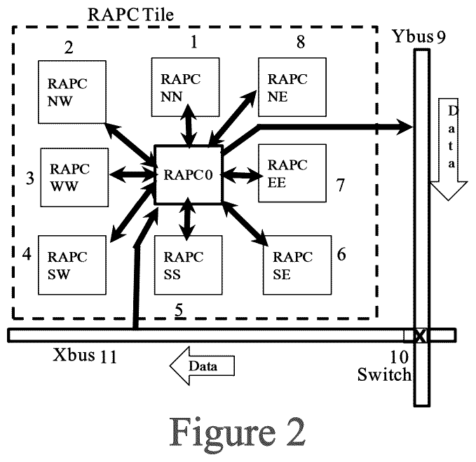

We build our RAPC with a more flexible XY layout instead of a straight ‘conveyor belt’, that can communicate with all adjacent RAPCs (FIG. 2), which shows a group of 9 RAPCs (a RAPC tile). RAPC tiles can be any number of RAPCs in the X and Y directions; we use a 3 by 3 arrangement here for convenience.

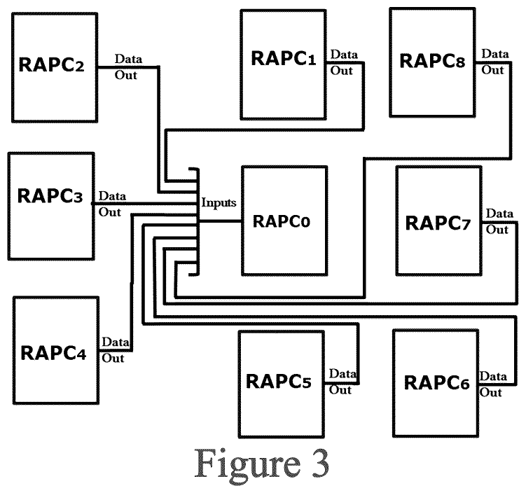

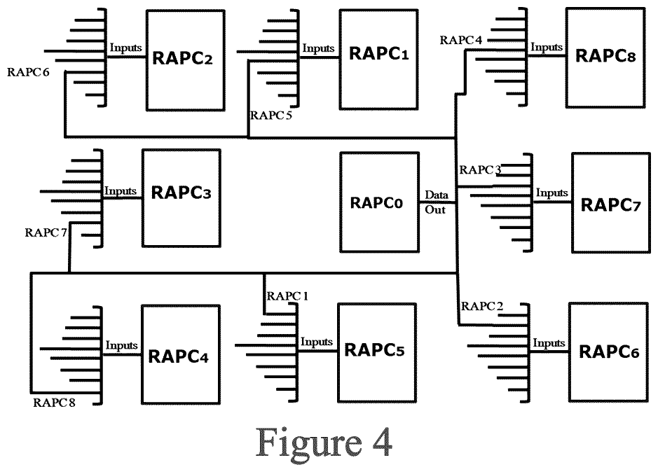

We build the structure in such a manner as to allow each RAPC to use the same relative addressing with respect to its surrounding RAPCs. Computing blocks are numbered relative to the RAPC at the center, starting at the top, going counterclockwise around the adjacent blocks. FIG. 3 and FIG. 4 show how we achieve this layout by offsetting the output bus of the center RAPC in the input bus tree of the adjacent RAPCs. Together with the RAPC's internal registers and sources, this results in a 4 bit address-a large reduction in RAPC gate count from the usual 32 or 64 bit addressing schemes.

Note that adjacent RAPCs can be reached using this same addressing scheme even if they are in adjacent tiles. The tile is merely a convenient grouping; each RAPC has access to all adjacent RAPCs and uses the same relative addressing arrangement.

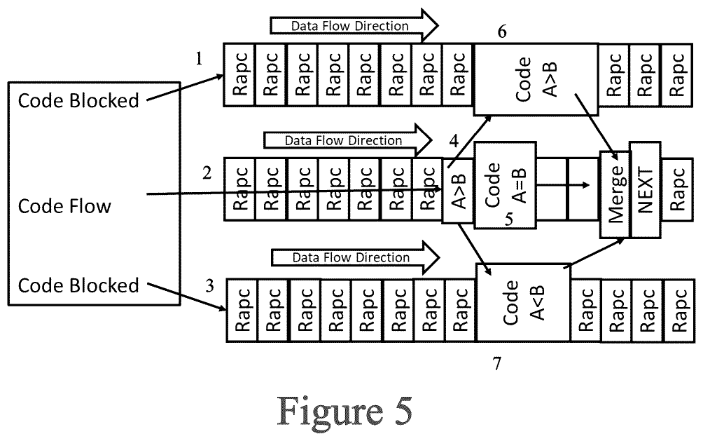

However, consider FIG. 5 where data flows left to right on adjacent paths 1, 2 and 3. A branch occurring at RAPC 4 can only avoid blocking dataflow in adjacent rows (6, 7) if it branches to RAPC 5. For all other branches the adjacent rows are blocked and become stalled. While we've simplified the RAPC, the simplest branch in a pipelined thread produces the need for adjacent row or column RAPCs to be used, which blocks program flow for other threads. The result is a drastic throttling back in performance, and/or loss of the use of significant real estate on the chip. Careful routing can gather back some performance, but multiple branches in any software thread are inevitable. We conclude that branching or decision making affects 2D layouts similarly to internal pipelines in more conventional CPUs; branching severely affects performance.

### Meta Tags and Source Addressing

We now show how to resolve this bottleneck problem using 3D computing. In our factory analogy, one factory operator may be tasked with more than one operation to reduce floor space. Different assemblies may require different routing. Factories attach a work tag to each assembly, telling the operators what to do with the assembly. Each assembly may require a completely different set of tools and parts as well as a different operation. The total group of these differing tools and parts, plus the instruction, are the context of each operation. The factory operator stores each context on a different shelf to keep things neat and orderly.

The operator receives only output from one particular predecessor and uses one set of tools to do his one operation. The operator qualifies the assembly based on who handed it to him (its source) and its corresponding work tag. Once he has done with his simple operation, he puts the data in his ‘out box’. He updates the work tag (context instruction) for ‘the next guy’ (whichever RAPC is looking for data from the operator). He does not care who uses his finished work; he only checks that his out basket is empty before he does the next operation. If the outbasket is not empty, he halts the entire upstream assembly line because someone didn't pick up his finished assembly.

Analogously in our RAPC fabric, we attach a meta tag to each data word, corresponding to the work tag. The meta tag is a pointer that selects which context (a single instruction, an internal constant, and any other necessary data) to use on the incoming data. The context is stored internally in the RAPC's registers, one set for each layer. The RAPC qualifies the incoming data; it looks only at the RAPCs it has been pre-programmed to expect new data from (source addressing). Both the source and the meta tag must be correct before the data is accepted.

### Z Levels

Instead of an involved program, the RAPC must do just one basic operation on the data, using the context determined by the source addressing and the meta tag. It then puts the results out with the appropriate (previous or updated) meta tag. In our example embodiment each RAPC will have up to four completely separate sets of contexts stored. The RAPC can perform up to four simple but completely different operations. The contexts are indexed by their Z level (think of a vertically stacked tool rack with four shelves, numbered 0 thru 3).

Once the RAPC's single operation is complete, the RAPC puts the results out on its single output register, along with a (possibly updated) meta tag. Adjacent RAPCs programmed to watch for its results are triggered by a ‘new’ signal or a ‘valid signal,’ and the meta tag, and use the results for the next operation in the sequence. These RAPCs are the downstream RAPCs.

Back in FIG. 2 the possible adjacent RAPCs that might accept output or provide input are shown (1 thru 8). In this example, we use 8 possible adjacent RAPCs. Hardware limitations may reduce the number of adjacent RAPC pathways to a number less than 8; this has little effect on the operation of the basic structure.

All RAPCs can read from or write to the surrounding RAPCs (or, in the case of the first RAPC in a row, to or from the MAU). Additional routing allows internal recirculation within the RAPC itself, and non-adjacent transfers are via a bus arrangement 9 thru 11.

This arrangement allows dataflow to be routed in any XY direction, to any adjacent RAPC, or to non-adjacent RAPCs.

### Source Addressing Eases Multi-Threaded Programming

There are additional advantages to source addressing. Source addressing uniquely enables very fast, fully synchronous multi-threaded responses to data computations with no overhead time. Several branches can be started all at once, a major advantage for multi-threaded situations. Unlike our factory floor where there is only one assembly being passed, if received data requires more than one program thread to process, more than one RAPC can be programmed to respond to the finished output. A single RAPC can start up to 8 other RAPCs simultaneously on the next clock if they are all programmed to recognize its meta tag output.

Further, each of the 8 adjacent RAPCs can then, on the succeeding Xclk cycle, start several more RAPCs in the same manner, resulting in at least 25 separate but fully synchronous program threads within 2 clocks of a single RAPC output. Notably, since the upstream RAPC can be programmed to watch the RAPC in question, the RAPC that has just completed the computation can restart the original source of the data on the next clock cycle. Thus, there are 8 possible destinations.

### Address and Program Structure Reduction

There is an additional reason for source addressing; size of the RAPC. Since most data is passed from adjacent RAPCs, relative addressing is used locally. 8 RAPC connections plus additional bus and internal register addresses require an address field of only 4 bits, a very large size reduction from the typical 64 bit address fields of many CPUs.

Also, instead of an involved program, the RAPCs now store one program instruction and a couple of possible output Z levels for each input Z level. So the program space for each RAPC is greatly simplified, with 1 executable instruction for each Z level.

We have now seen how source level addressing and a very short (single) program instruction greatly reduce the RAPC size, and allow one RAPC to start several simultaneous threads within a single clock cycle.

### 3D Programming: The Z Axis Abstraction

How can the user grasp and effectively use the meta tags? Two abstractions help the visualization immensely.

In the first abstraction, the Z value corresponds to the tool set shelf number we discussed previously. However, we will reinterpret this context index number as a computing dimension; the third dimension of RAPC fabric computing, the Z axis.

Of all the computational elements, RAPC blocks take up the largest physical area in the chip layout. We presume in this high speed chip that only one data set per Xclk cycle can enter or leave the device; using separate RAPCs for each level would be a waste of resources. So we multiplex these blocks to further reduce physical size.

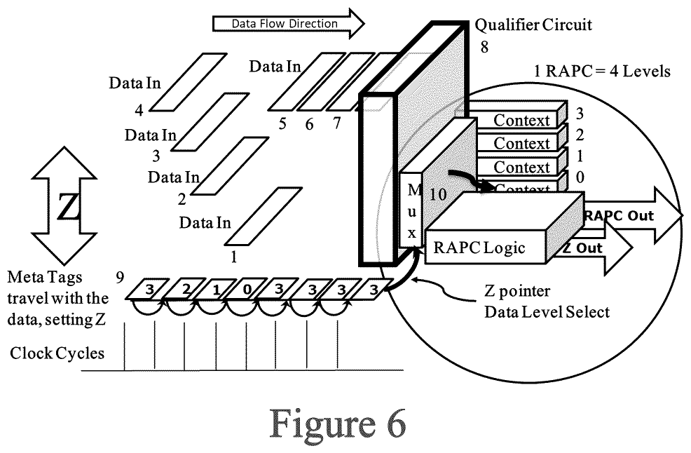

A 4 level multiplexing logic scheme is shown in FIG. 6 for a computation that only requires one input. A RAPC block is presented with data words 1 through 7, in this example traveling to the right. Each data word is tagged with its Meta Tag 9 that accompanies it through the computing matrix. The Meta Tag is an indirect pointer that the qualifier circuit 8 uses to set the MUX (multiplexer) 10 to process its data with the correct context. The address contained in the Meta Tag is the layer number and is referred to as the Z axis. The RAPC structure looks to the programmer like 4 completely separate computational units, one for each of the four levels. There is complete data and computation isolation for any thread executed on a given Z level, without requiring context storage or any extra time to shift between levels, eliminating a great deal of overhead.

Since only one calculation can be completed per clock cycle, there is only one output and meta tag per clock cycle, which allows easy shifting between levels if desired without adding Xclks, due to the pre-stored contexts.

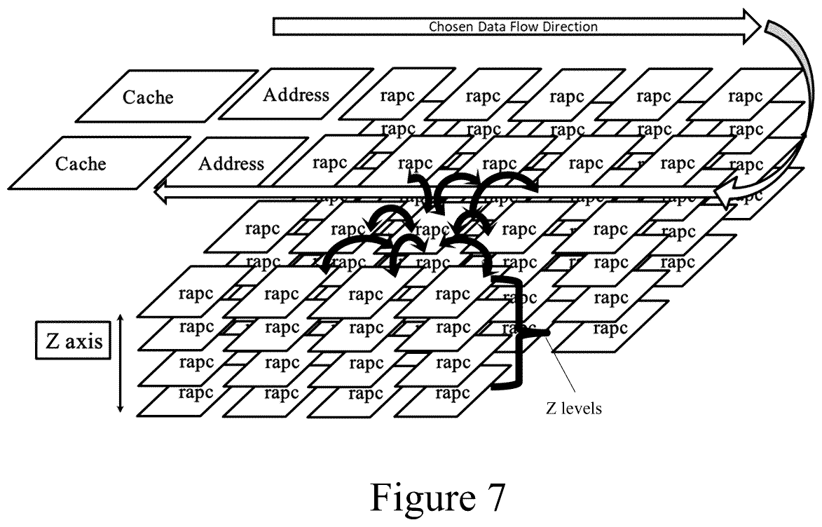

Using this abstraction, we set up the user's model to ignore these physical details and expand it to allow full XYZ inputs and outputs so it looks conceptually like FIG. 7 to the programmer.

### Folding

One could refer to use of the different Z layers as being stacked on top of each other. A more apt abstraction is that computations can be visualized as being ‘folded’ on top of each other in layers, because connections between layers can be fully functional, and usually will be. Each layer is isolated from adjacent layers unless the user deliberately causes data to cross between layers. Each additional layer correspondingly reduces the total area needs of the fabric, at the tradeoff of total throughput capacity.

### Branching in the RAPC Fabric

This arrangement helps real time computing in several ways. In our 3D computing model, the Z axis eases dataflow routing by setting the meta tags for each data to guide it through the layout on the appropriate Z level.

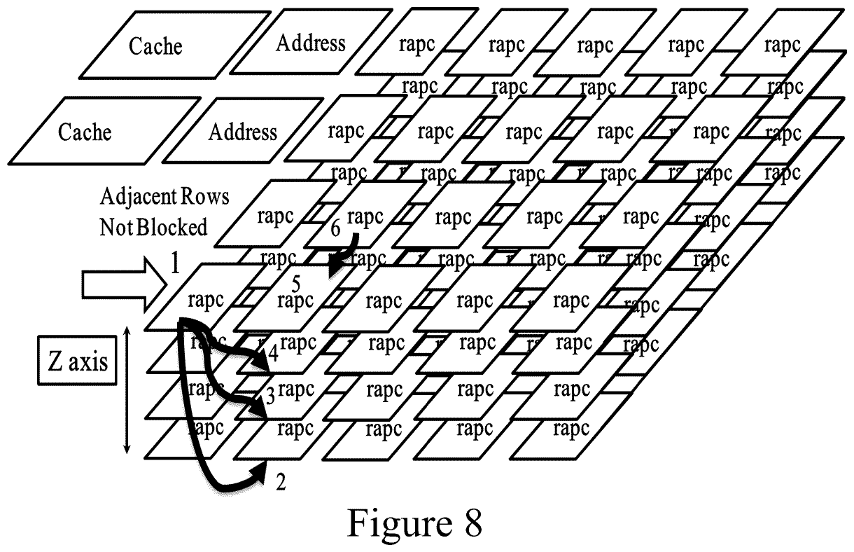

With the addition of the Z axis, the XY blocking problem is relieved. The 3 way branch shown originally in FIG. 5 is redrawn in FIG. 8 abstracted as a physical 3 way Z axis branch starting with RAPC 1, with ‘separate’ abstract RAPC cores 2, 3 and 4 (although in reality, only one RAPC is performing all 3 operations). Instead of branching to adjacent computing rows, RAPC 1 changes the Meta tag depending on the results of a test or the results of a computation. The new Meta tag value ‘requests’ the appropriate context from the downstream RAPC, which is now physically all located in the same downstream RAPC. The data can continue following that context level (Z level) through successive RAPCs until another RAPC redirects it to another level. A downstream RAPC can reset the Meta Tag to a predetermined value when the data arrives on any of the 3 paths, regardless of the source value, closing the separate branch paths. This is a MERGE operation.

### Priority

What happens if two dataflow pipelines need to use the same RAPC? The Z levels have different priorities. We have chosen level 0 as the highest priority, with higher Z values being successively lower priorities. In dataflow pipelines that use a common RAPC where a collision occurs, the highest priority Z value path is executed, while the next lower priority Z value pipelines are paused and must briefly wait. Throughput of the lower priority threads is lowered by the combined Xclk cycles used by higher priority threads.

Note that there is no timing overhead added by the branch.

### 3D Branching Prevents Adjacent Row Blocking

In 3D dataflow the adjacent row RAPC calculations are no longer blocked because the branching can all be contained within the next RAPC in the row. This advantage holds even if a branch to adjacent rows is performed (FIG. 8).

If a branch from RAPC 6 is called for, it can branch to ‘abstract’ RAPC 5, which still allows RAPC 1 to branch to ‘abstract’ RAPCs 2, 3 and 4. Generally, if the adjacent rows are not using all of their Z levels, they can still be branched to on an unused Z level, with completely isolated dataflows. Instead of adjacent flows being halted, cycles are stolen from the adjacent rows as necessary if the branch occurs to a higher Z level. If the branch is to a lower priority Z level, then the current algorithm waits until the other algorithm allows execution to continue. So adjacent rows process their normal algorithms on one Z level but can also handle overflow from the BRANCH on different Meta Tag settings. The programmer can select which algorithm needs the most clock cycles, and arrange layers accordingly. Branching can now be handled in several manners with minimal or no timing impacts.

There is also a corresponding increase in connectivity. Note that instead of 7 possible branch locations in 2D, the 3D branch can jump to any Z level of all adjacent RAPCs, allowing 31 possible logical destinations (This includes the upstream RAPC as well as long as the upstream RAPC that provided the branch has other unused layers). So there is effectively a large increase in ‘adjacent’ RAPCs.

### Reentrant Computing

Because the contexts are isolated (encapsulated), many data words can pass through the pipeline in succession. Data can ‘flow’ through on every single clock cycle, with up to Z different processes. In software terms, the dataflow path can be made fully or partially reentrant, meaning new data can be processed while the current data is still completing its pipeline journey without fear of unwanted interaction.

### How 3D Routing is Used

We now relax the restriction of single input and output in our assembly line analogy to provide a more realistic example.

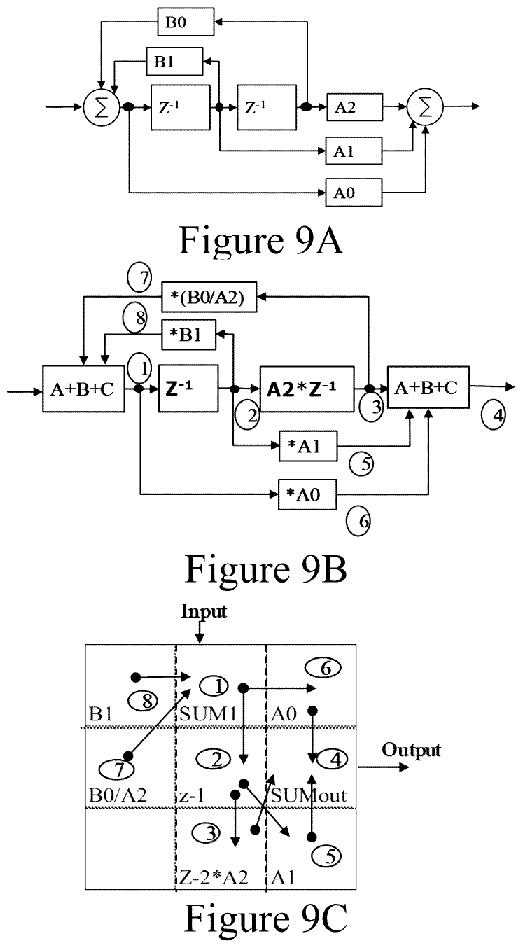

FIG. 9A shows a typical 2 pole, 2 zero digital filter in block diagram form (often referred to as a signal flow diagram). We convert this to RAPC blocks by numbering the outputs as in FIG. 9B. This algorithm requires two computation types; A+B+C, and A*B+C, which the RAPC designer has included in its instruction set. FIG. 9C represents each RAPC in this 9 RAPC tile as a simple square, with arrows showing the data flow between RAPCs. We arrange the RAPCs so the inputs and outputs are adjacent to each other (FIG. 9C). Data will be brought in at the top RAPC, and out to the right side. By counting blocks, we find that it takes 5 Xclk cycles of latency to compute one filter result. However, the filter is re-entrant, meaning that it can calculate one output while calculating another input. So the total throughput is 1 complete filter operation per Xclk cycle. This arrangement puts 8 RAPCs to work simultaneously to achieve this result.

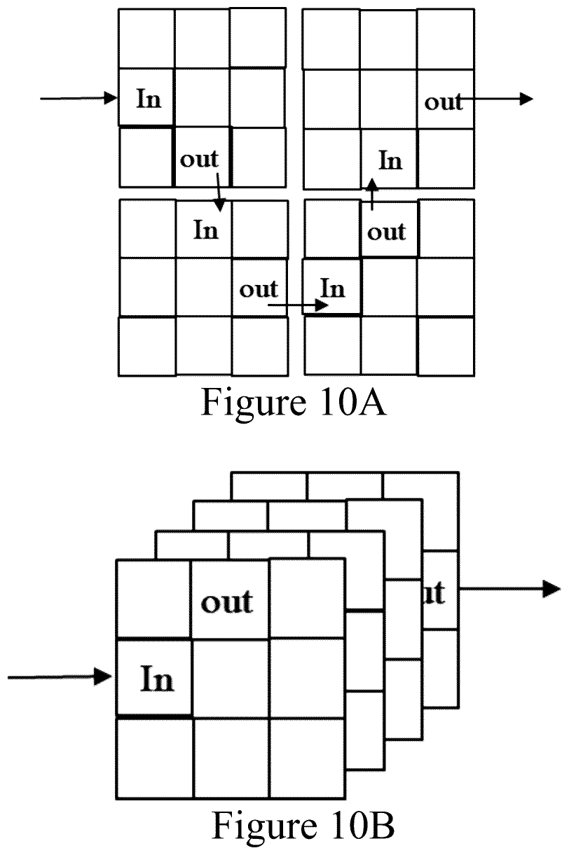

In FIG. 10A we see that, by flipping and rotating the calculation positions, we can build 4 filters in series. We find a total of 20 cycles of latency by adding cycles. However, the throughput is still 1 complete filter operation per Xclk cycle because we now are using 32 of the 36 RAPCs to calculate a filter at a very high throughput rate.

But if the filter doesn't need to run this fast, we can use the Z axis (FIG. 10B), stacking or folding the filter algorithms on top of each other, one full filter in each layer. Each filter feeds the filter calculation on the layer below it, by changing the Zlevel at the end of its filter calculation. Now, throughput drops by 4:1 because we're multiplexing the CPUs. But we've cut the number of RAPCs used by 4:1, which saves a lot of chip area.

This example demonstrates a new tradeoff in this architecture not available in other architectures. We can trade throughput for algorithmic density to get better hardware use when ultimate speed is not needed. Since most algorithms have only a small part of the calculations on the critical timing path, the Z axis will directly increase algorithmic density as the number of layers increases.

Since the Z axis is programmable, the user can make these speed/density tradeoffs after building and testing his design because the routing and Z layering are both programmable via the RAPC fabric. More Z axis layers built into the RAPC gives more algorithmic density the user can get from his RAPC fabric, while allowing the user increased flexibility during development.

Note also how simply the timing of the calculation was found by merely counting blocks, and including the folding. The synchronous throughput timing is also easily achieved through automated means. It is fairly easy to move and stack or fold algorithms as necessary to achieve timing goals either before or after the hardware is designed.

### Data Collisions, Priorities and the Upstream Halt

It may be that more than one Z level calculation is requested of a given RAPC—or, not all the arguments arrive on the same clock edge. We now discuss this concern.

In our assembly line analogy, each operator can stop the line if he runs out of parts. The RAPC has the same capability; it can assert the upstream halt (Uhalt\) signal. Uhalt\ halts the pipeline upstream until valid data is received for all the required arguments. If, for example, more than one argument is needed but only 1 has arrived, the RAPC asserts Uhalt\ for the data that has arrived, preventing it from being overwritten, until the missing arguments have all arrived.

Also, if a higher priority algorithm needs to use a given RAPC, the Uhalt\ signal of that RAPC is asserted for lower priority data paths, until the higher priority block is finished.

An alternative is to include a latch within the RAPC that captures the data when it is presented. One latch would be required for each Z level. Each RAPC typically uses more than one argument, each of which may have its own upstream data path. The RAPC sends Uhalt\ to each upstream RAPC that has presented finished data until all required operands are present.

### 3D Summary

3 Dimensional folding, then:

Increases computational density by reducing the number of RAPCs needed to handle a given task, for a given program size, by trading off speed when algorithms are folded on top of each other in the Z axis.

Allows branching and merging without slowing down calculations while also greatly easing the mapping problem
allows a major increase in algorithmic density and computational efficiency over a standard 2D XY layout by unburdening adjacent dataflow paths;
prevents or greatly reduces timing variations for simple branches;
allows the data to use completely different computational contexts on every Xclk cycle in the same pipeline with zero overhead timing.

Allows one RAPC to handle multiple independent operations

Maintains data separation and thread independence while reducing or eliminating timing variations caused by necessary routing considerations.

Allows full pipelined operation, running multiple program threads through the same hardware, while maintaining complete separation of data or context for each thread.

Allows new tradeoffs between execution time and layout size.

The number of Z axis levels needed will depend on expected customer code construction and required code density (‘computational density’).

### The Fabric Structure

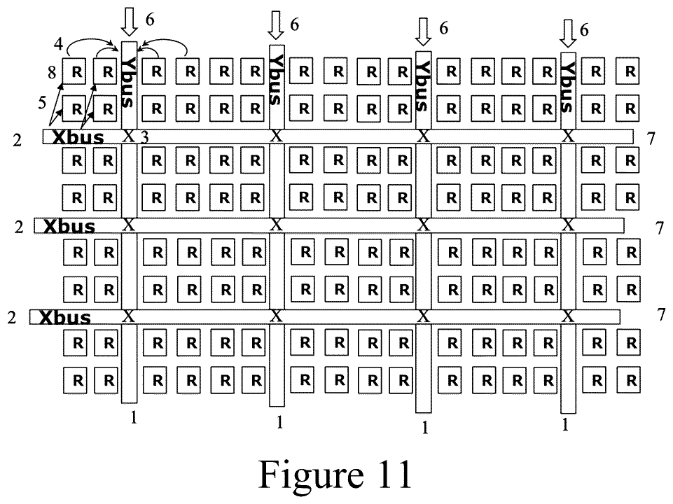

A conceptual 2D RAPC fabric layout using 4 by 2 tiles is shown in FIG. 11. Each and every RAPC is connected to its immediately adjacent 8 RAPCs as previously shown in FIG. 3 and FIG. 4. An example bus connection is shown at the upper left. There, the Ybus 6 receives data from the RAPCs 4, 5, 8, and others which are then routed through crosspoint switches 3 to the Xbuses 2. The Xbuses then allow the RAPCs to receive data from any non-adjacent RAPC through judicious routing of the data through the switches.

### DETAILED INVENTION DESCRIPTION

We now describe an embodiment of the RAPC structure that implements 3D computing. After a brief introduction we will proceed through a block by block description in a top down fashion.

Simulation schematics built in Simulink will be used to describe the RAPC architecture.

For illustration purposes we assume each RAPC block will accept 3 arguments so it can do a multiply-accumulate operation (or MAC), performing the equation

$$Output = A * B + C .$$

More or fewer arguments for any operation may be used as long as the maximum number of arguments and Z layers is fixed in the RAPC design.

### RAPC Internal Structure Overview

### Conventions

In the following diagrams:

Signals with a-Bus suffix represent groups of signals, such as a data bus.

In Simulink buses are used to make the model visually tractable, simplifying routing.

In Simulink there is no need to draw a group of 8 gates on a data port; one puts a single gate on the bus line, which then operates on all the signal lines in that bus.

In the MATLAB language, the colon represents ‘all of the values’. A (:,1) would be a two dimensional structure, referring to all the rows in column 1.

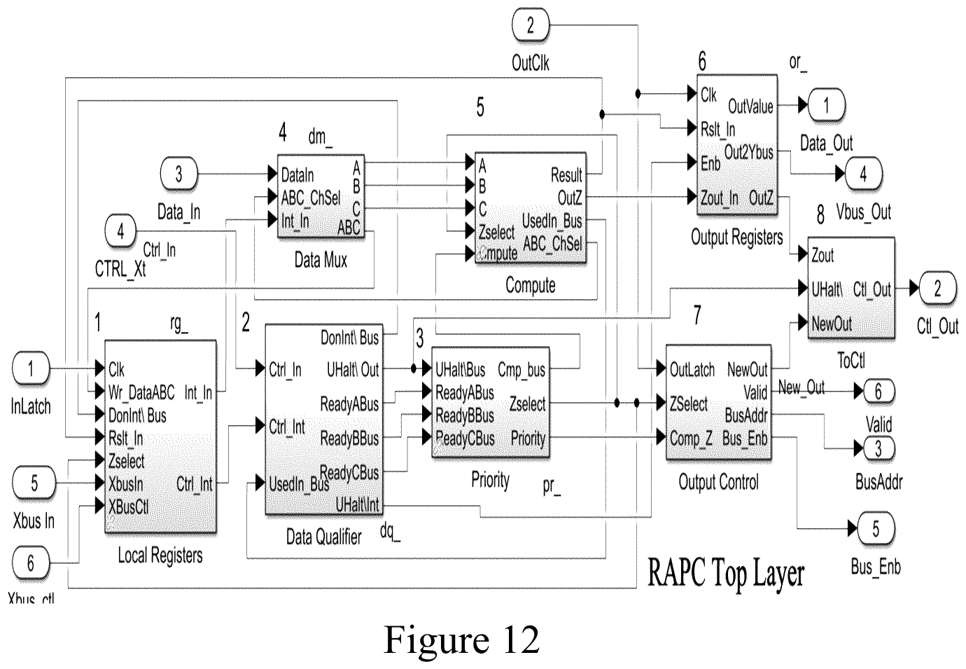

The internal structure of a single RAPC is shown in FIG. 12. The RAPC consists of the following blocks (the 2 letter prefixes are used in all descriptions of each block content):

Local Registers (rg_) 1 allow temporary storage, the use of constants, recursion, and some debug capture capability.

Data Qualifier (dq_) 2 inspects the A,B and/or C inputs to ensure the arguments needed for the compute instruction are ready to use and come from the desired source and input Zlevel. The data qualifier also handles the UHalt\ signal, which is distributed to and from the adjacent RAPCs.

Priority (pr_) 3 pre-empts a given Z level if a higher priority input is ready to be calculated. The highest selected Zlevel which has all its arguments present is passed on to the Compute block to select the calculation instruction.

Data Mux (dm_) 4 receives the data bus for each of the A,B or C arguments from either an external or internal source, supplying it to the Compute block.

Compute (cm_) 5 does the calculation using the supplied arguments and Z level, and presents the results to the output and local registers.

Output Registers (or_) 6 latch the data and output Z level for transmission to the next external data user.

Output Control (oc_) 7 provides the NewOut, Valid, Uhalt\ and bus control signals to external users.

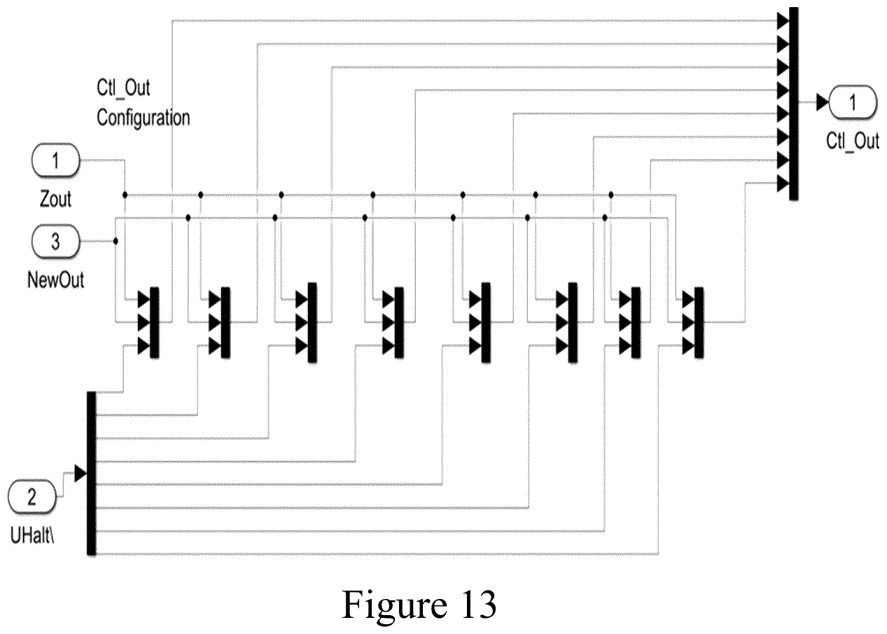

ToCtl (no suffix) 8 contains no active circuitry. It provides a bus reorganization area. (FIG. 13) to simplify the schematics.

### Principal Variables

The data path width is represented by the variable Pwidth.

The Z path width is represented by Zwidth, usually a power of 2.

### Control Signals

### Rapcs Use 3 Signals to Coordinate Operations:

New (or NewOut): This signal alerts all external data users that a new data and Zlevel have been clocked into the RAPC output registers. The double label is a simulation artifact.

Valid: This signal informs all external data users that the data and Z level in the output registers is valid. It allows for initialization, loading and other system needs as well.

In some situations, output data will be needed more frequently than calculations are completed. In this situation, the output circuitry is set up to respond to only the Valid signal and ignore the New or NewOut signal. Then the output circuitry may read the RAPC data at any rate it needs to run at. This arrangement specifically allows for upsampling or downsampling the data to adjust for differing sample rates.

Uhalt\: (stands for upstream halt). This signal ensures that the pipeline runs only at the speed the slowest operation can handle. It informs all external inputs to wait and hold their current output data until all the necessary arguments have been received, thus synchronizing all the arguments necessary for a calculation. Uhalt\ is propagated upstream to the entire pipeline. It can arise from 3 sources in this embodiment:

If any of the arguments needed for a RAPC computation are not present, then UHalt\ must be sent to the upstream RAPCs that have presented valid arguments, to prevent the current data from being overwritten.

If the downstream RAPC can't accept data for some reason (such as processing a higher priority algorithm step), it will send an upstream halt.

Rarely, an internal process will require a halt. This could be during load, or if the RAPC is waiting for a bus operation to complete (bus operations are considered internal).

If the RAPC internal calculations determine the throughput rate, then Uhalt\ is used to throttle the input to a speed the RAPC can handle, while Valid and/or NewOut can be used to indicate to the output circuitry when the data has been updated or can be used. If the data requires synchronicity, then Valid must be used to guarantee a 1:1 transfer of the results.

### Clock and Timing

A single clock is provided, Xclk. A major advantage of this architecture is its simple timing. This example embodiment uses a single clock to process all the transfer operations in the architecture. The Xclk runs at a speed that allows the longest possible RAPC computation to complete. Functions internal to the RAPC in this embodiment use no internal clock; they run as fast as propagation delays will allow.

### RAPC Sub-Blocks Functional Description

The Data Qualifier block provides the best overall understanding of the controls and data discrimination required to implement the 3D architecture.

### Data Qualifier

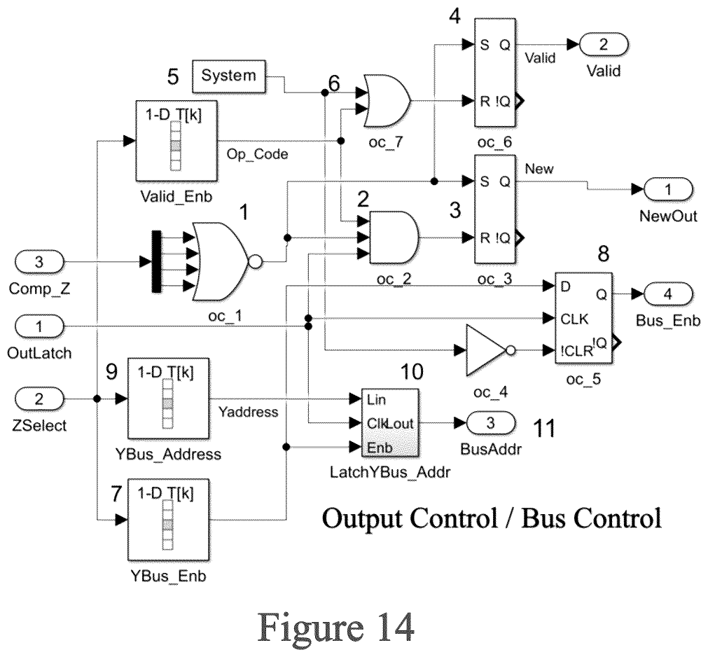

The data qualifier block (FIG. 14) consists of:

A bus sorter block 1, which has no active circuitry. This is merely a schematic convenience that regroups the external and internal control signal buses Ctrl_Int and Ctrl Xt into the internal buses NewBus, Zbus, HaltBus and Uhalt\Int.

A Usedin_Bus 2 that indicates which of the A,B or C arguments are used for each of the 4 instructions stored in the Compute block. A lookup table in the compute section generates signals corresponding to the number of arguments in the desired (single) instruction for the selected Z level that the circuit is looking at. Note that inputs A,B and C can be received from different Z levels and sources.

The setup inputs 3, 4, 5. These are preloaded constants that focus the appropriate ReadyCheck block on just the desired Z level, input data port and UHalt\ input.

3 groups of ReadyCheck circuits 6 ,7 and 8, one group for each possible input argument. If 4 arguments are needed, then an additional group of Z ReadyCheck blocks needs to be added.

Two UHalt\ routing blocks 9, 10 that reassign any UHalt\ signals to the proper upstream (Uhalt\ Out 11) or internal (DonInt\ Bus 12) output, so Uhalt\ gets routed to one of the adjacent 8 RAPCs, or one of the 8 internal UHalt\ signals.

Outputs from the block are indicator buses 13 that arguments for A,B and/or C are ready to be used. These signals are sent to the priority block.

### Data Qualifier Channel A

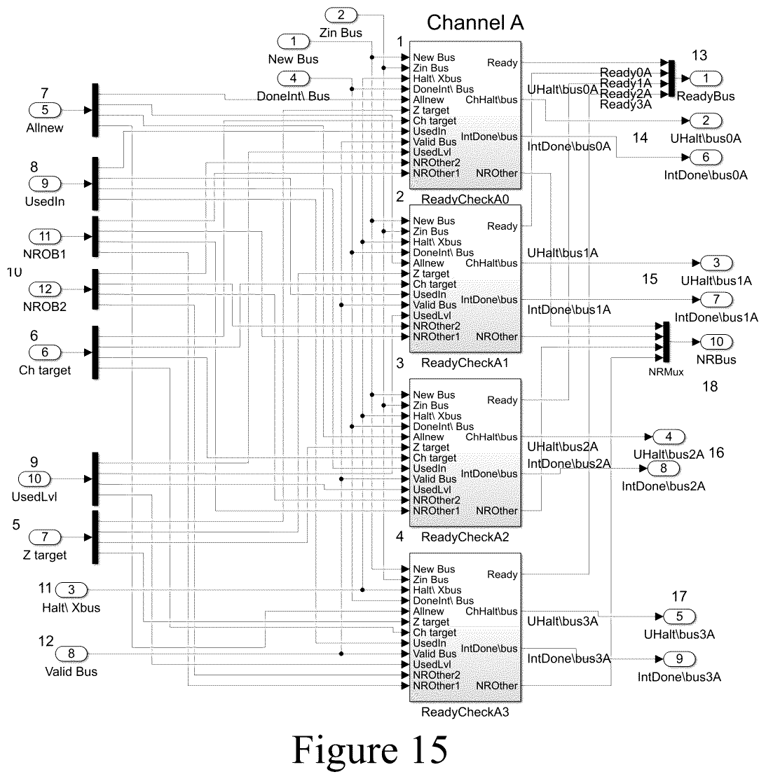

We look more closely at the A argument group from FIG. 14, in FIG. 15. We see 4 identical ReadyCheck blocks 1,2,3 and 4 that look for the correct channel and Z level from each possible input. The setup required for circuit operation is to input the desired Z level (Z target 5, 2 bits), input address (Ch target(1:4) 6, 4 bits) and a signal called Allnew (1 bit) 7, which allows the NewOut signal to be ignored, thus allowing disparate sample rates to be accommodated. We also need enable circuitry, UsedIn 8, which blocks action for unused arguments, and UsedLvl 9 which blocks action for unused Z levels.

The Halt\ bus 11 is brought in from external blocks, and the Valid Bus 12.

We have also signal groups NROB1 and NROB2 which will be explained at the next lower level.

It can now be seen how the ReadyBus 13 is formed from the individual ReadyCheck blocks 1 through 4, the Uhalt Bus and IntDone\bus 14 through 17, and the NRBus 18 are grouped.

### The ReadyCheck Block

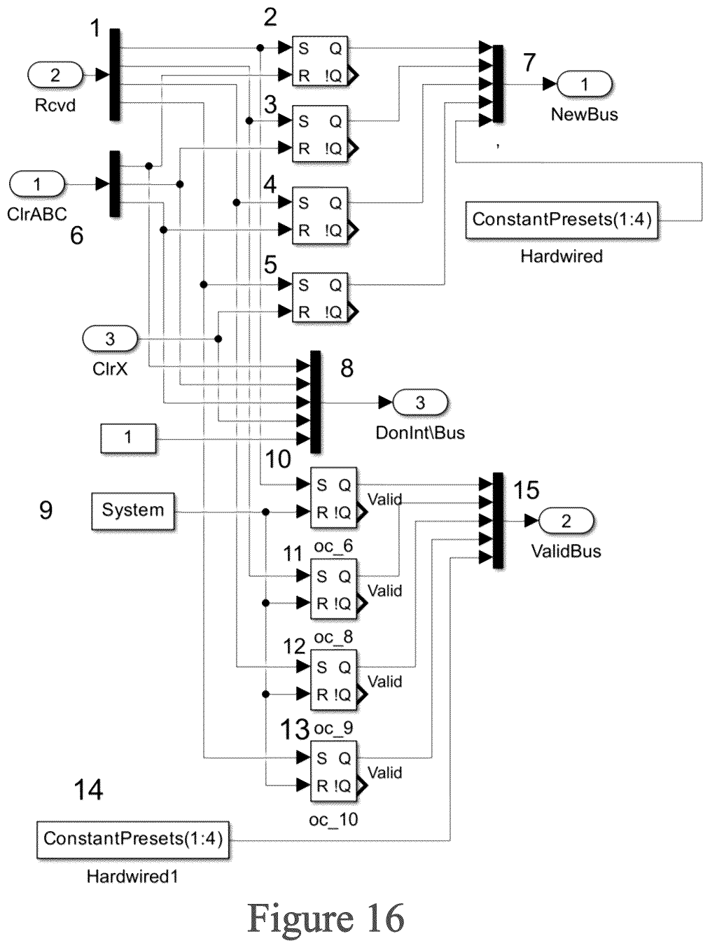

Now we look at one of the ReadyCheck circuits from FIG. 15. This sub-block (FIG. 16) consists of 4 16 channel MUXes 1, 2, 4 and 7, preset by Ch_target to direct attention to the appropriate input. If the following conditions are met for the target channel:

### Valid 1 Is True

the Z level input 4 from the upstream RAPC matches the preset Az input 5,

NewOut 2 is active (or optionally Allnew 3 is set) on the selected RAPC input.

Then the ReadyGate line 6 is asserted.

The output Ready signal 7 is further interlocked with setup signals UsedLvl and UsedIn 8 in case this ReadyCheck block is not active.

The Uhalt\ signal is generated when this ReadyCheck block has an argument that is ready to be used but other channels and Z levels providing arguments are not ready. This is the purpose for the NROther signal 9.

If a UHalt\ is received from the selected downstream channel through 7, 10, 11, or needs to be generated internally through 12, 13 and 11, Uhalt\ is generated. The corresponding ChHalt\bus outputs are sent as UHalt\ to the addressed source (of the 8 surrounding RAPCs) if an argument is missing from the calculation from block 14, a 4:16 decoder.

If the Uhalt\ source is internal (DonInt\), the equivalent signal is sent via IntDone\bus to the internal source.

### Priority Block

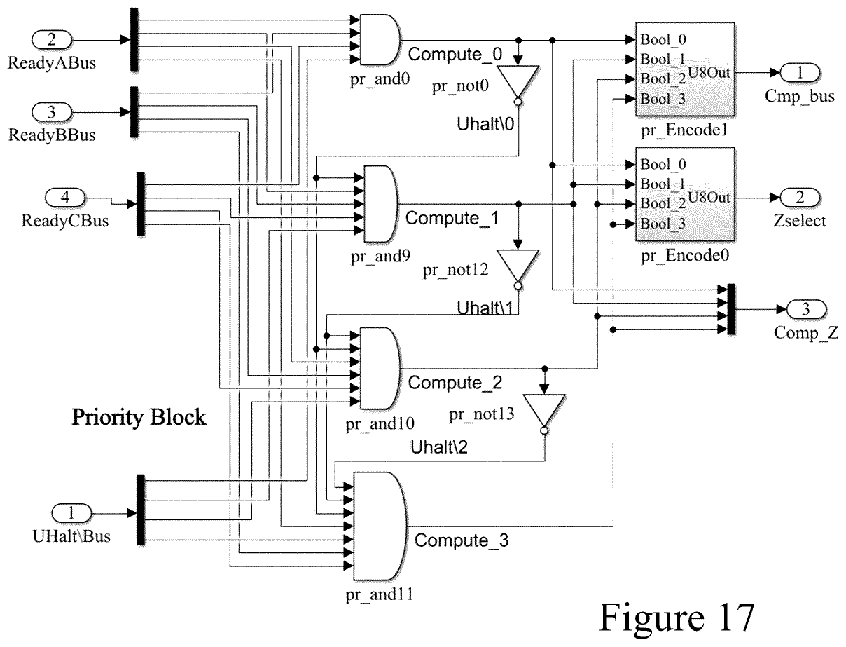

From the data qualifier block, when a computation is ready to be completed because all arguments are present, the ReadyA, ReadyB and/or ReadyC signals are sent to the priority block (FIG. 17). Here, priorities resolve any simultaneous calculation requests from different Z levels. The block has been set up to give Zlevel 0 the highest priority in this embodiment.

The Comp_Z and Zselect signals inform other blocks of which Z level is to be used.

The Cmp_bus tells the computation unit which computation to perform by sending a Z level signal also.

### Data Mux

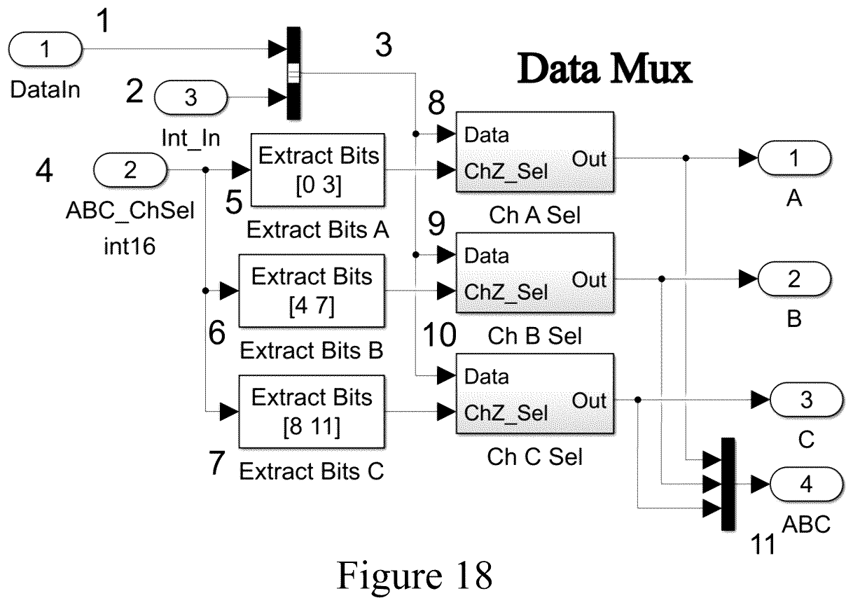

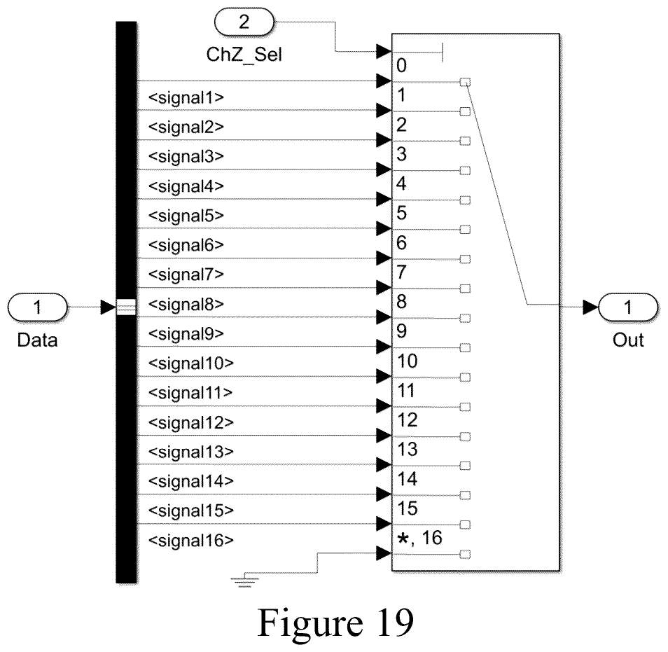

The data mux (FIG. 18) is a set of 3 channel multiplexing circuits 8, 9 10 that choose the appropriate input or internal data source for each A, B or C input using the proper bits from the ABC_ChSel input. It then routes the source to the proper input for the computation to be performed (FIG. 19).

### Compute Block

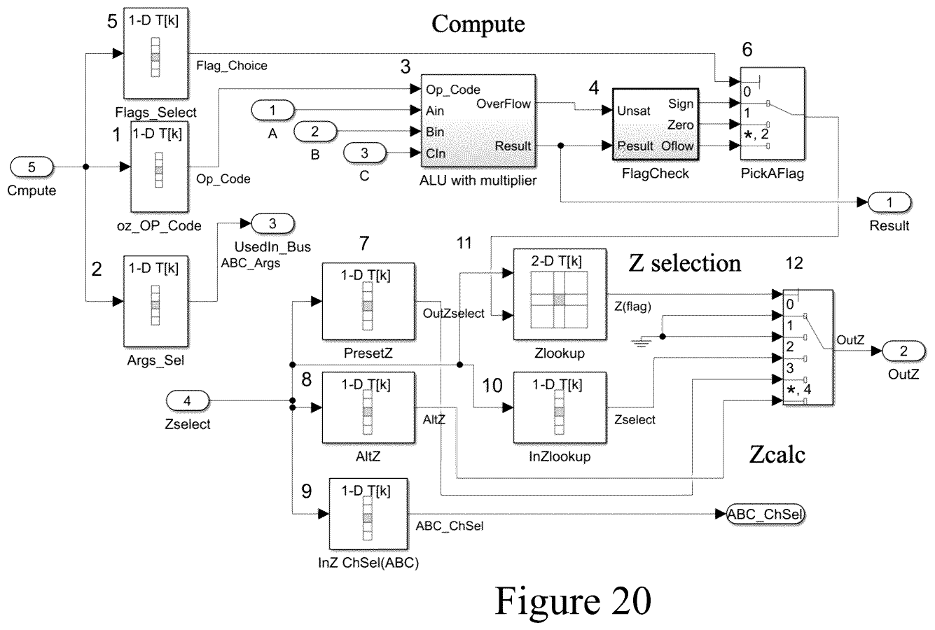

The compute block (FIG. 20) is the main calculation engine. The example computation engine is enabled by the Cmpute signal, which selects the op code that determines the single instruction to be selected via table 1. The correct arguments needed for the desired Z level and address are looked up in the table 2 and applied to the UsedIn Bus signals.

The ALU 3 does the desired calculation, generating the Result and Overflow indicator. The FlagCheck block 4 checks for various output conditions and sets an appropriate flag. If the user sets a flag check in block 5, the appropriate flag is sent to the Z selection section

table 11. This table allows various Z levels to be sent to the next RAPC based on the input Z level and the result flags.

Though the ALU block 3 is arguably the heart of the RAPC, the design of computation arithmetic logic units is well known, so is represented in block form only. The instruction set is determined by customer needs. Details of the computation are not relevant to data routing and movement.

Block 6 selects the various flags generated by the ALU 3 Depending on the choice the user makes in block 5, various flags can be used.

The Z selection section calculates the new Z for the output. MUX 12 driven by the LUT 11 determines which lookup table to use. The Zlevel can be determined by the selected flag in table 5 through blocks 4 and 6 to block 11, a preset value in LUT 7, an alternative value in LUT 8, or the selected input Z in 9, or the input Z level in LUT 10.

### Output Registers

The output data registers are a full word wide, latching on the Xclk clock. 2 Sets are necessary, a wide one for the calculated value and a narrower one for the Z level. A second optional set can be included for the bus structure due to routing considerations and enable differences (not shown).

### Output Control

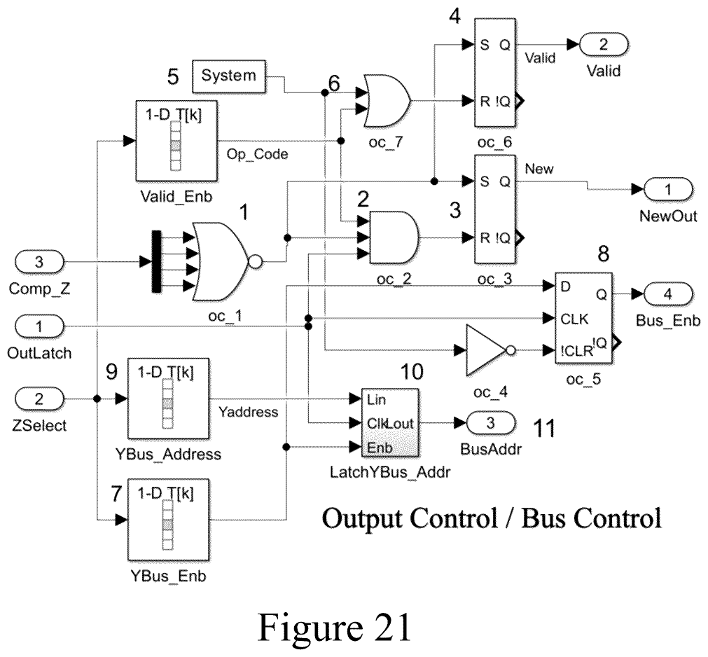

The output control block in FIG. 21 contains additional timing signals to allow synchronized calculations. Also, it enables the bus if the user sets up the Z level instruction for bus activity.

### Output Control Operation

Gate oc_1, 1, detects a computation on any Z level (Comp_Z), setting Valid 4 and NewOut 3 flipflops if output is needed as set by LUT 5. Gates 2 and 6 allow system actions to override the valid outputs for system actions 5 like load or power on reset.

Bus output and control registers 8 and 10 provide a bus interface for sending data and pre-programmed addresses to the Ybus. The bus addresses stored in 9 and the bus enable versus ZSelect table 7 also provide control of the bus signals.

### Local Registers

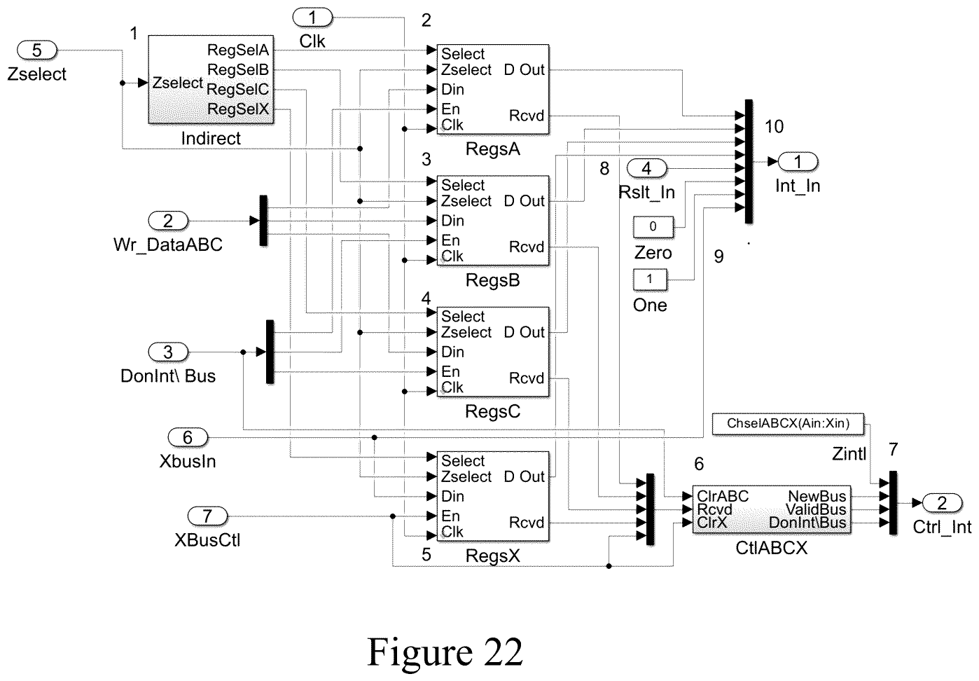

A variety of applications may require differing register arrangements to accommodate various algorithms. This example embodiment (FIG. 22) includes features most customers are expected to request.

### Local Registers Overview

This embodiment incorporates capture latches 2,3,4,5 for various options:

capturing the upstream data, qualifying it by Z level.

Outputting the data directly 8.

Providing various commonly used constants 9

Providing address indirection 1

Providing Xbus captures 5 It also generates the necessary internal control signals 6.

Input capture latches used to record the data output of the upstream RAPC can then be presented to the compute section on the following clock, again to allow recursion, data recirculation, data delays and integration.

### Data Registers

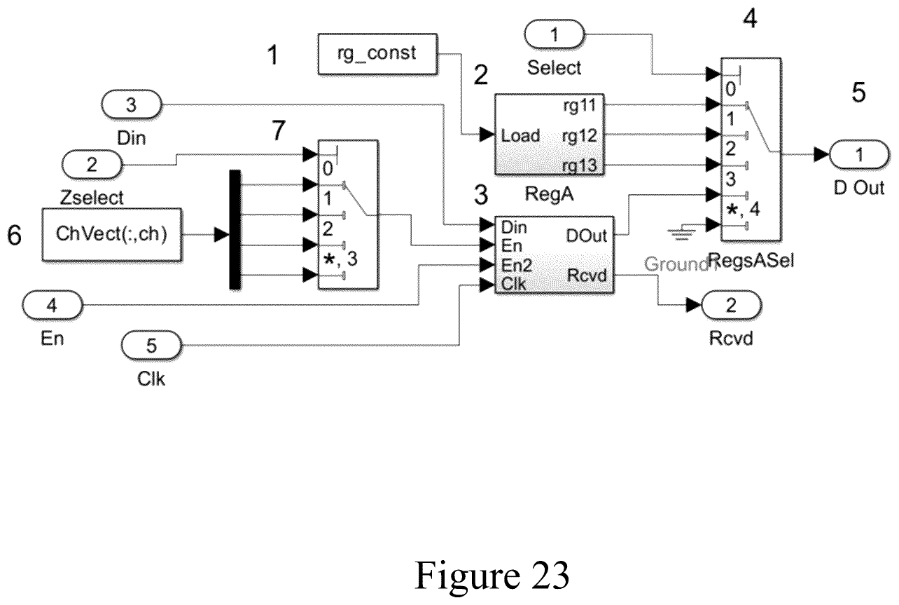

Looking into identical blocks 2 through 5 of FIG. 22, in FIG. 23 we find that various program constants 1 can be loaded into any one of 3 registers 2. These 3 constants, or the output of the capture register 3 are pointed to by the select line driving the MUX 4. The capture register 3 can be enabled to select input data from any channel as set by the LUT 6, the Zselect line and the Clk signal.

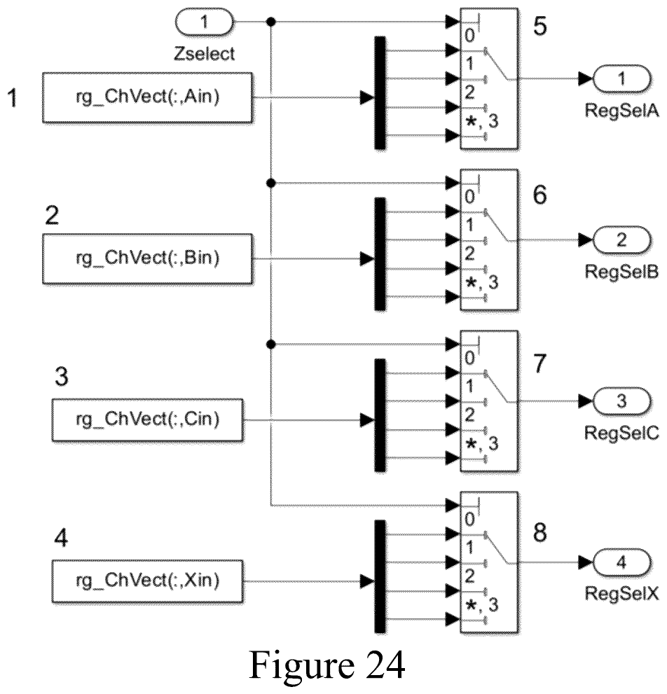

The indirect block 1 of FIG. 21 is shown in more detail in FIG. 24. The LUTs 1 through 4 allow any register in the register block to be repeatedly addressed as a function of the Z level by providing an additional 2 bits of address. This also allows some indirection to be used, to enable data from one Z level to be used in another Z level as needed.

### Register Block Control Signals

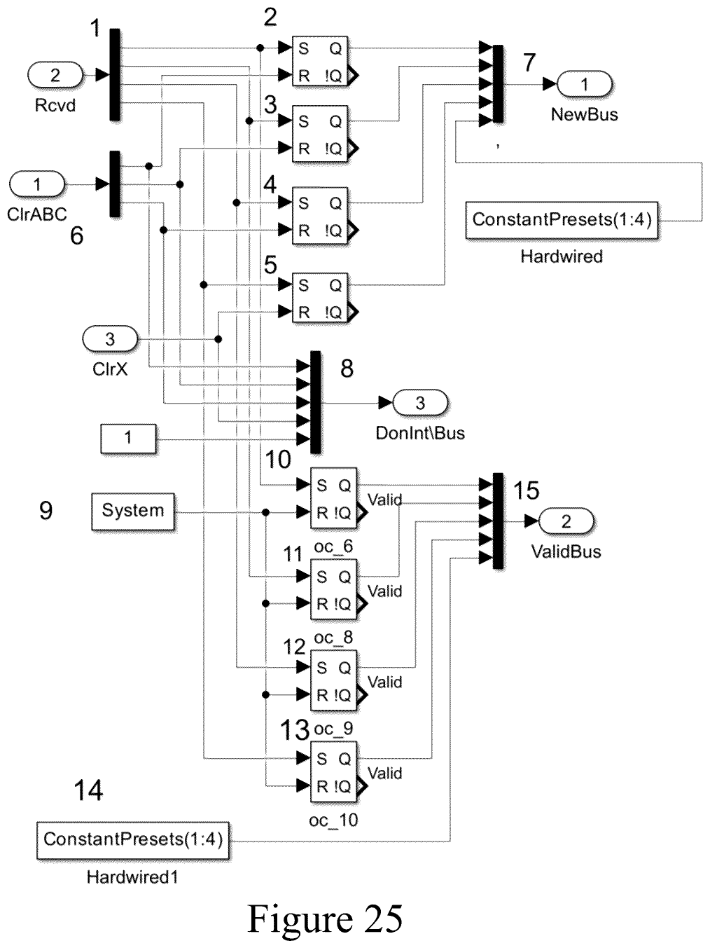

The control signals block 6 of FIG. 22 is detailed in FIG. 25. Similarly to other generators, this block provides a momentary NewBus signal 7 using flipflops 2 through 5, when new data is received. Each NewBus signal must be cleared in the following clock cycle by ClrABC. The ValidBus 16 is cleared only when the system functions reset it. Constants that are hardwired can also be generated in 14.

### Input/Output Driven RAPC Fabric

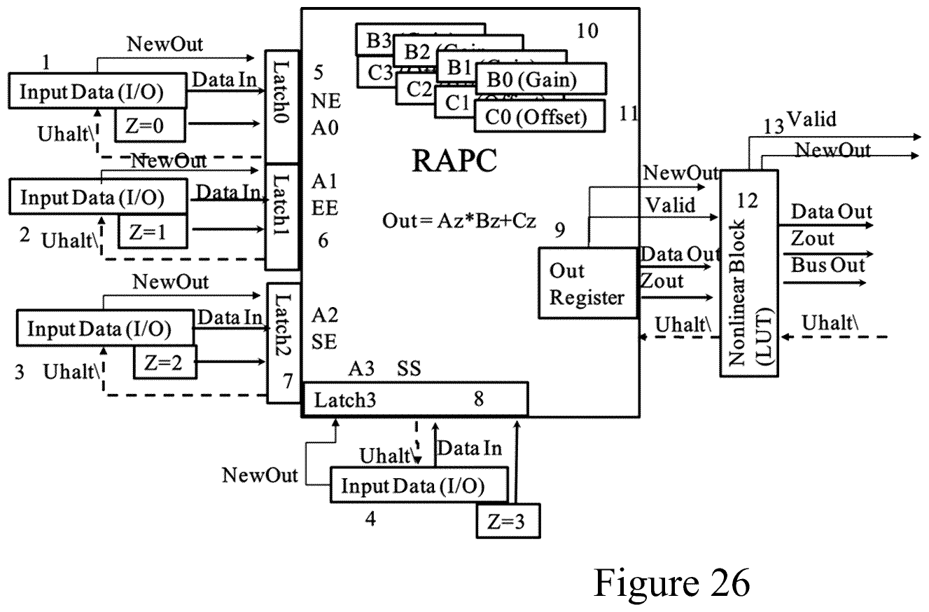

A special case arises when data from external circuitry is hardwired into a RAPC (FIG. 26). The RAPC is set up to receive and condition data from an exterior input, such as an analog to digital converter or resolver, in which the input has a high data rate. The RAPC receives data from input registers 1 through 4. For all 4 identical inputs, the corresponding incoming NewOut signal latches the data into the input latch of the RAPC. In this particular case, the input channels NE 5, EE 6, SE 7 and SS 8 are pre-programmed to recognize Z values from 0 to 3 to establish the priority and prevent data collisions. External data is brought in as the A argument (A0 through A3, 5 through 8). The input registers are triggered by the NewOut signal from the I/O channel. There is no need for the ‘valid’ signal in this instance, as the latches are triggered by this signal.

The typical 10 or 12 bit unsigned binary data is multiplied by gains B0 through B3 from the internal registers. Then an offset (C0 through C3), also stored in internal registers, is added to convert the value to signed binary. The output register then receives the result, which in this embodiment is passed through a Nonlinear block 12 to correct any nonlinearities.

The data can arrive in any order. The programmed Z values ensure an orderly processing, and each of the four inputs gets its associated gain and offset. If all 4 data arrive simultaneously, the processing takes care of the calculations in priority order, with 0 being the highest priority.

Each output value is captured in the Out register 9, where the RAPC NewOut and Valid signals are now generated. The Nonlinear Block 12 receives the data, uses it to address the lookup table LUT, and replaces the incoming value with a compensated value.

If the nonlinear block is used, the Nonlinear block must drive a full complement of up to 8 RAPCs as necessary, just as a regular RAPC output register would. However, since this is a 4 Z level design, there is no need to put out more than 4 independent values. The nonlinear block can be designed to use 4 different tables in this case (such as Sine, Cosine or Tangent).

### The Memory Address Unit (MAU)

### MAU and Cache Structure

The memory address units of FIG. 1, FIG. 7 and FIG. 8 have two jobs—to bring data into the RAPCs, and to send data back to the cache memory in a coherent, block structured manner. This is complicated by the independent nature of the four layer structure, which can be running completely different types of algorithms on each layer.

Our MAU example embodiment will assume data synchronicity in its operation, as the main issue is the routing of the data.

### MAU Structure Overview

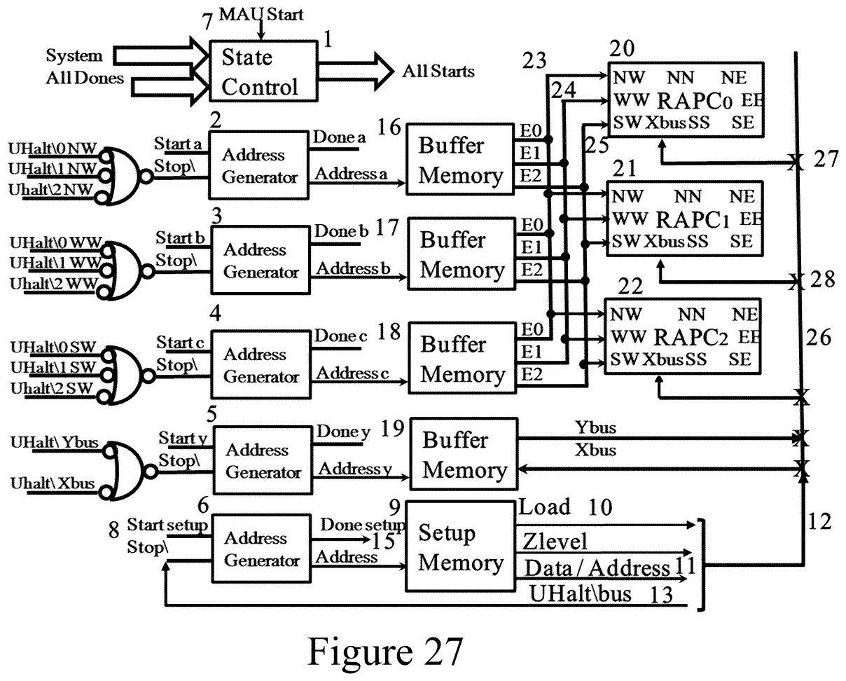

The MAU (FIG. 27) will receive input data (structured elsewhere) for the RAPCs into buffers, then provide the data to the A,B and/or C RAPC inputs for an arithmetic operation (the actual number of inputs is dependent on what the RAPC is programmed to do). It may be necessary to provide more than one MAU input block if multiple algorithms running at differing rates are installed on different Z levels, or if the number of independent algorithms is large.

### Mau Description

### Mau Input Operation

The general approach is shown in FIG. 27. Initially the state control module 1 and address generators 2-6 are loaded and configured. The MAU starts when the MAU Start line 7 is asserted. Then Start setup 8 is asserted. The setup memory 9 takes the address from address generator 6, asserts the Load line 10 and begins delivering the setups and initial register contents on its Data/Address bus 11 via the Ybus. Any current operations from other MAUs on the bus will cause UHALT\bus to be asserted from the bus switch 12, thus arbitrating the load sequence.

Once the RAPCs and bus are initialized, Done Setup 15 is asserted to the State Control module 1. The MAU structure of the newly loaded Z level is now ready to compute.

The State Control module 7 now starts the sequencing of Address Generators a thru c and y (2 thru 5) as needed to deliver data and/or coefficients from Buffer Memories 16 thru 19 to RAPC0 20 thru RAPC2 22. These RAPCs use source addressing. Each RAPC is programmed to choose which of the buses E0 thru E2 (23 thru 25) or the Ybus 26 (supplied by Buffer Memory 19) is the data it needs. Any or all of the RAPCs can use the same data.

The Ybus 26 is routed through the programmed bus switches 27 thru 30 (represented by X), to the expected Xbus appropriate to the desired RAPC. Data can be sent to any or all of the RAPCs, allowing full parallel synchronous operation, or any single RAPC as desired.

### The MAU Output Structure

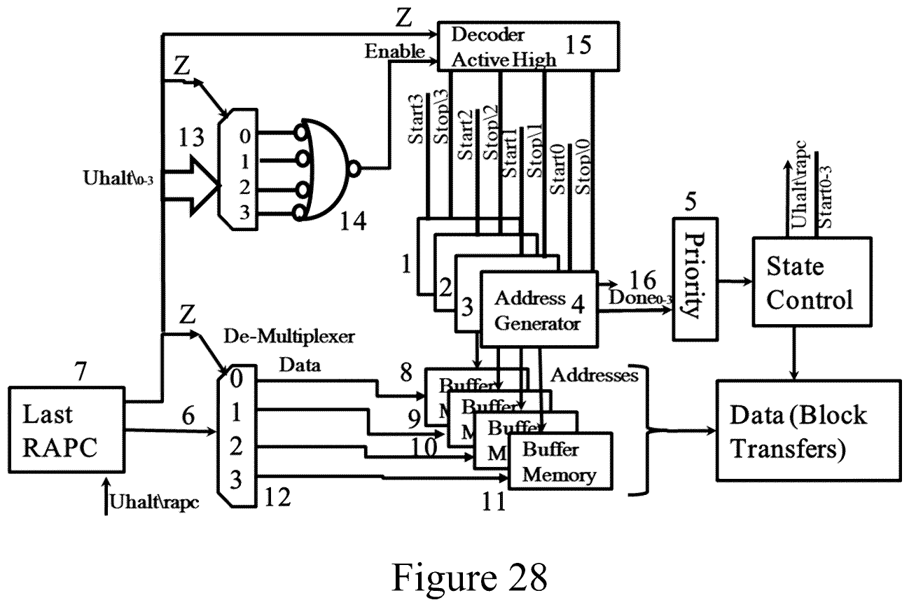

As is true in the input structure, there are a variety of ways to receive data from the RAPCs and send it back to the system once it has been processed by the RAPCs. The actual configuration will depend on the type of data being processed. One embodiment is shown in FIG. 28 for transferring large blocks of data output with 4 independent algorithms running simultaneously, where the output block size is known for each algorithm.

Initially the block size and start addresses for each algorithm are programmed into the Address Generators 1 through 4. A priority scheme for each algorithm can be hardwired by Z value, or an arbitrary arrangement can be set into the Priority block 5, to resolve collisions.

Data 6 coming from the last RAPC output register 7 in one RAPC in the RAPC fabric is selected by its Z value to be installed in the appropriate Buffer Memories (8 through 11) through demultiplexer 12. Since there can only be one data set (A,B and C) per clock in this design, the buffer memories can be a single memory with reserved areas, as set by the Address Generators 1 through 4. If more than one RAPC is used for output, separate Buffer Memories could be needed.

The Z meta tag value is also used to decode the Uhalt\ value 13 for the data being presented to the buffers. Or gate 14 and active high decoder 15 ensure that only the right Address Generator advances when the data for a given Z level is presented. The address generated is then used to store the data in the corresponding buffer memory 8 thru 11.

The first Address Generator that signals Done 16, or the highest priority Done asserted, enters the state control module. This module begins the data transfer to the bulk memory outside the system. The exact transfer mechanism depends on the data transfer protocol.

The state control module holds off the other transfers until data transfer is complete. If another Done signal is received, the Uhalt\rapc signal is asserted for that Z level to ensure that no data is lost or overwritten. The last RAPC then passes the Uhalt\ signal back upstream to halt the other calculations until the buffer is emptied and ready to receive data again.

Once the block transfer has completed, the Start line for the transferred data is asserted to reset the counter, the Uhalt\rapc line for the last RAPC is deasserted, and other transfers can be started or resumed.

If higher transfer rates are desired, or if data content larger than the buffer size is to be transmitted, the wraparound feature of the address counters can be used to transmit blocks of a given size, allowing the buffer to be partially emptied. In this situation, the input Address Generator address would have to be compared with the output Address Generator and a Uhalt\ signal would be generated if the addresses are ever equal.

If the computations are asynchronous or of variable length, the input and output address generators will have no dependable relationship to each other; the Uhalt\ line will stop some data upstream of the output buffers.

### Address Generators

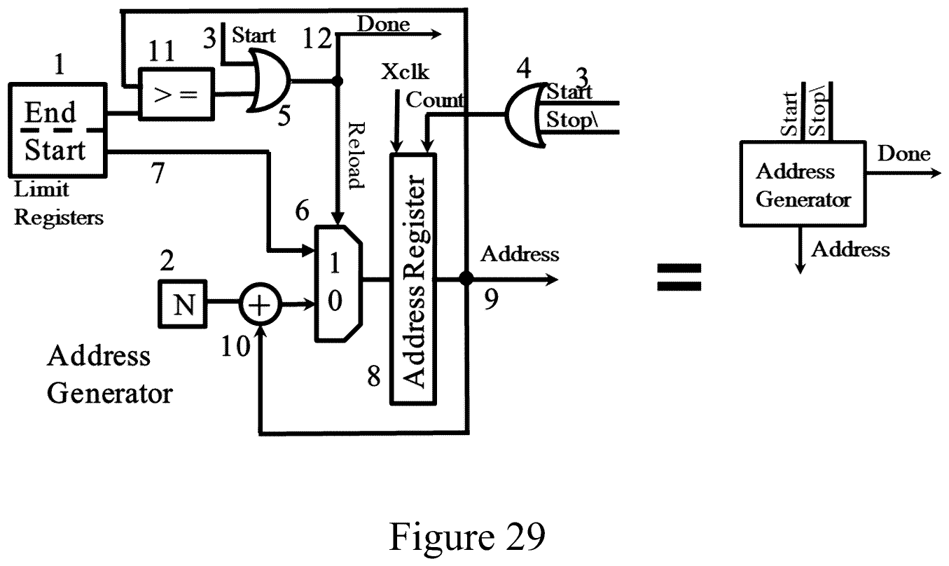

The address generators are simple counter arrangements with variable start, stop locations and step sizes (FIG. 29). In both the input and output MAU structures we use a simple address generator circuit, a modified up counter that starts from an initial count, can count by integer multiples, stops at the end count, and can wrap around if necessary for the data flow. Operation is as follows:

After loading the start and stop addresses into the limit registers 1, and the address spacing value Nin 2, Start 3 is asserted. This overrides the Stop\ signal 13 through or gate 4, and forces the initial reload by or gate 5. Multiplexer 6 then applies the Start address 7 to the address register 8 input. Xclk then installs the initial address. Start is then deasserted to allow normal counting operation.

The address 9 is applied to the adder 10. If Stop\ is asserted, the address count stops. If Stop\ is deasserted, the address+N is applied to the address register 8 through the multiplexer 6. When Xclk occurs, the Address+N is loaded into the register, and the counter counts up.

When the address reaches or passes the End value stored in the limit registers, the comparator 11 causes a reload, and the counter starts over with the Start value.

The Done signal 12 (which is just the Reload signal) signals to external logic that the counter has finished its count. If Stop\ is asserted at that point externally, the counter halts. If Stop\ is not asserted, the counter wraps around to the beginning address and continues generating addresses spaced N values apart.

Unlike typical massively parallel computing designs, the RAPC fabric can be laid out once. Timing is easily determined due to the highly repetitive block nature of the RAPCs. Once the algorithm layout has been configured in RAPC fabric hardware, it is a simple matter to determine timing. Simply put, all motion is tied to Xclk. Execution time is calculated by adding up the number of Xclks required to execute an algorithm. Throughput is similarly calculated. This simplicity separates the hardware timing issues from the algorithm layout, allowing readjustments in routing algorithms to be easily done without having to reanalyze the RTL timing of the hardware. Since the configuration registers are settable in software, it is a simple matter to revise or completely reorganize the user's algorithms.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A 3-dimensional computing system comprising:
a. computing elements regularly spaced in 2 dimensions along an X and Y axis, with multiple data paths between adjacent computing elements,
b. circuitry configured to: execute computing algorithms on data on multiple configurable data paths using successive computing elements, wherein a 3rd dimension of which accompanies the data as a metatag is used to direct and change the data path thereof.

2. The 3-dimensional computing system of claim 1, wherein the computing elements implement algorithms requiring branching and merging in 3 dimensions by dynamically changing the metatag.

3. The 3-dimensional computing system of claim 1, wherein the data path is dynamically altered in 3 dimensions by changing the metatag according to computing results.

4. The 3-dimensional computing system of claim 1, wherein algorithms are organized in layers indexed by the 3^{rd} dimension such that multiple programmable independent data paths can be configured on each layer, allowing data encapsulation and computing context isolation by layer.

5. The 3-dimensional computing system of claim 1, wherein a 2 dimensional data bus allows non-adjacent computing elements to communicate data and metatags, wherein data is received from computing elements on one axis, then is supplied to the computing elements on a second axis, through at least one configured switch.

6. The 3-dimensional computing system of claim 1, wherein the data is fetched from and supplied to local memory through a memory address unit separate from the computing elements, wherein the memory address unit is configured to add the 3^{rd} dimension metatag to the data, wherein the memory address unit is configured to accommodate multiple independent computing data paths, and wherein the memory address unit responds to and stores data according to the metatag accompanying the data.

7. A memory address unit according to claim 6, wherein input and output are linked.

8. The 3-dimensional computing system of claim 1, wherein the circuitry comprises a Reconfigurable Arithmetic Pipeline Core (RAPC) computing element configured for using multiple arguments for a computing function, wherein each individual argument's source and metatag determines its participation in the data path.

9. The 3-dimensional computing system of claim 8, wherein the RAPC is further configured to store multiple instructions, computing contexts and meta tag output values, whose execution order can be determined by an input data source and the metatag accompanying the data.

10. The 3-dimensional computing system of claim 8, wherein the computing element synchronizes the input arguments by:
pausing any or all of the upstream data sources until all necessary data is present,
pausing upstream sources when downstream destinations request a pause, and
pausing upstream sources when internal operations are not complete.

11. The 3-dimensional computing system of claim 8, wherein the RAPC is further configured to capture its own output data for use in subsequent operations.

12. The 3-dimensional computing system of claim 8, wherein output of the RAPC is broadcast to all adjacent RAPCs whose computations are configured to immediately start multiple additional data paths.

13. The 3-dimensional computing system of claim 8, wherein output of the RAPC is set to always valid to allow multiple data rates.

14. The 3-dimensional computing system of claim 8, wherein internal computation of the RAPC needs no internal clock, whose logic design only needs a single output transfer clock.

15. The 3-dimensional computing system of claim 8, wherein the RAPC having at least one argument supplied from a digital input port, where multiple input ports supply a metatag to determine input port priorities and the conditioning of input data.

16. The 3-dimensional computing system of claim 1, wherein the 3-dimensional computing system is a field programmable gate array (FPGA) specifically programmed to perform the functions of (a) and (b).

17. A Reconfigurable Arithmetic Pipeline Core (RAPC) computing element of a 3-dimensional computing system in which computing elements are regularly spaced in 2 dimensions along an X and Y axis, with multiple data paths between adjacent computing elements, the 3-dimensional computing system comprising circuitry configured to: execute computing algorithms on data on multiple configurable data paths using successive computing elements, wherein a 3rd dimension of which accompanies the data as a metatag usable to direct and change the data path thereof, the RAPC comprising:
circuitry configured for using multiple arguments for a computing function, wherein each individual argument's source and metatag determines its participation in the data path.
